(19) United States
(12) Patent Application Publication
(10) Pub. No.: US 2026/0317490 A1
(43) Pub. Date: Oct. 15, 2026

(54) GLUCOSE LIMITING LAYER FOR A CONTINUOUS BIOLOGICAL SENSOR

(71) Applicant: Allez Health Inc., Carlsbad, CA (US)

(72) Inventors: Robert James Boock, Carlsbad, CA (US); Brendan McCarthy, Encinitas, CA (US)

(73) Assignee: Allez Health Inc., Carlsbad, CA (US)

(21) Appl. No.: 19/640,594

(22) Filed: Apr. 7, 2026

Related U.S. Application Data
(60) Provisional application No. 63/786,494, filed on Apr. 10, 2025.

(51) Int. Cl. C08J 3/24; C08J 5/18; G01N 27/327

(52) U.S. Cl. CPC C08J 3/24; C08J 5/18; G01N 27/3272; C08J 2383/07

(57) ABSTRACT

A method for forming a glucose limiting layer for a continuous biological sensor includes applying a solution to a substrate for the continuous biological sensor. The solution includes vinyl-terminated polydimethylsiloxane (PDMS) and a crosslinker to form a layer on the substrate. The substrate is exposed to an initiator thereby crosslinking the vinyl-terminated PDMS with the crosslinker in situ. A glucose limiting layer for a continuous biological sensor includes a substrate for the continuous biological sensor. A layer is on the substrate, and the layer includes vinyl-terminated PDMS and a crosslinker. The vinyl-terminated PDMS is crosslinked to the crosslinker.

### RELATED APPLICATIONS

This application claims priority to U.S. Provisional Application No. 63/786,494, filed on Apr. 10, 2025, entitled “Glucose Limiting Layer for a Continuous Biological Sensor”, the contents of which are incorporated herein by reference in their entirety.

### BACKGROUND

Medical patients often have diseases or conditions that require the measurement and reporting of biological conditions. For example, if a patient has diabetes, it is important that the patient have an accurate understanding of the level of glucose in their blood. Traditionally, diabetes patients have monitored their glucose levels by sticking their finger with a small lance, allowing a drop of blood to form, and then dipping a test strip into the blood. The test strip is positioned in a handheld monitor that performs an analysis on the blood and visually reports the measured glucose level to the patient. Based upon this reported level, the patient makes important decisions on what food to consume, or how much insulin to inject into their blood. Although it would be advantageous for the patient to check glucose levels multiple times throughout the day, many patients fail to adequately monitor their glucose levels due to the pain and inconvenience of the finger-sticking process. As a result, the patient may eat improperly or inject either too much or too little insulin. Either way, the patient has a reduced quality of life and a heightened chance of doing permanent damage to their body and overall health. Diabetes is a devastating disease that if not properly controlled can lead to terrible physiological conditions such as kidney failure, skin ulcers, bleeding in the eyes which can lead to blindness, pain and the eventual amputation of limbs.

Regular and accurate monitoring of glucose levels is therefore critical for diabetes patients; in the most ideal scenario, their glucose levels are monitored continuously. Enter continuous glucose monitoring (CGM) sensors—a type of device in which glucose is automatically measured from fluid sampled in an area just under the skin multiple times throughout the day. CGM devices typically involve a small plastic form factor housing the necessary electronics, adhered to the patient's skin and worn for a finite length of time. A small needle within the device delivers the sensor to the subcutaneous space and immediately begins sensing glucose, the mechanism of which is often electrochemical in nature. In this way, a patient may install a CGM on their body, and the CGM will provide accurate glucose monitoring continuously, for many days automatically, without any input or action required from the patient or caregiver. It will be understood that depending on the patient's needs, reporting of the continuous glucose monitoring may be executed at different intervals. For example, some continuous glucose monitors may be set or programmed to take multiple readings per minute, whereas in other cases the CGM can be programmed or set to take readings every hour or so. It should be understood that a CGM may sense glucose and report readings at different time intervals.

Continuous glucose monitoring is a complicated process, owing largely to the known fact that glucose levels in the blood can significantly rise/increase or lower/decrease rapidly, for a myriad of reasons. As such, a single glucose measurement provides but a snapshot of the instantaneous level of glucose in a patient's body with no information on how the patient's use of glucose may be changing over time, nor how the patient reacts to specific dosages of insulin. Without this information even a patient adhering to a strict schedule of strip testing may very likely be making incorrect decisions with regard to diet, exercise, and/or insulin injection. And for a patient who is less consistent in performing their strip testing, this dilemma is only exacerbated. In order to give the patient a more complete understanding of their diabetic condition—and in so doing get a better therapeutic result—many patients now use continuous glucose monitoring to manage their diabetes.

Electrochemical glucose sensors operate by using electrodes which typically detect an amperometric signal resulting from the enzymatic oxidation of glucose to gluconolactone; the amperometric signal can then be correlated to the glucose concentration. Two-electrode (also referred to as two-pole) designs use a working electrode and a reference electrode, where the reference electrode provides a reference against which the working electrode is biased. The reference electrodes essentially complete the electron flow in the electrochemical circuit. Three-electrode (or three-pole) designs have a working electrode, a reference electrode and a counter electrode. The counter electrode replenishes ionic loss at the reference electrode and is part of an ionic circuit.

Conventional CGM systems typically use a working wire composed of a tantalum core on which a thin layer of platinum is deposited. Tantalum is a relatively stiff material and can be pressed into the skin without bending—although an introducer needle may be used to facilitate insertion—it is fairly inexpensive when compared to platinum, and makes for an economical working wire. Next, an enzyme layer is deposited over the platinum surface, able to accept oxygen and glucose molecules from the user's blood. The key chemical processes for glucose detection occur within the enzyme layer. Typically, the enzyme layer has one or more glucose oxidase enzymes (GOx) dispersed therein; when a molecule of glucose and a molecule of oxygen (O₂) are combined in the presence of the glucose oxidase, a molecule of gluconate and a molecule of hydrogen peroxide (H₂O₂) are formed. In one construction, the platinum surface facilitates a reaction wherein the hydrogen peroxide reacts to produce water and hydrogen ions, and two electrons are generated. The electrons are drawn into the platinum metal driven by a bias voltage placed across the platinum wire and a reference electrode. The magnitude of electrical current flowing in the platinum is proportional to the number of hydrogen peroxide reactions, which are proportional to the number of glucose molecules oxidized. In this way, measurement of the electrical current on the platinum wire can thereby be associated with a particular level, or concentration, of glucose in the patient's blood or interstitial fluid (ISF).

Unfortunately, the current cost of using a continuous glucose monitor is prohibitive for many patients who might otherwise benefit from its use. As generally described above, a continuous glucose monitor has two main components: the first component houses the electronics, processor, memory, wireless communication and power supply. This housing is often reusable, over an extended timeframe, typically months. The housing connects or communicates to the second component, a disposable CGM sensor, which is adhered to the patient's body and uses an introducer needle to subcutaneously insert the working wire into the patient. Since the CGM sensor is not reusable but disposable, it must be replaced, as often as every three days, and likely at least once every other week; thus the cost of purchasing new disposable sensors poses a significant financial burden to both patients and insurance companies. Consequently, a substantial number of patients who might otherwise benefit from using continuous glucose monitoring may be priced out of using such systems and are forced instead to depend on the less reliable and infinitely more painful, finger-sticking monitoring system.

### SUMMARY

A method for forming a glucose limiting layer for a continuous biological sensor includes applying a solution to a substrate for the continuous biological sensor. The solution includes vinyl-terminated polydimethylsiloxane (PDMS) and a crosslinker to form a layer on the substrate. The substrate is exposed to an initiator thereby crosslinking the vinyl-terminated PDMS with the crosslinker in situ.

A glucose limiting layer for a continuous biological sensor includes a substrate for the continuous biological sensor. A layer is on the substrate, and the layer includes vinyl-terminated PDMS and a crosslinker. The vinyl-terminated PDMS is crosslinked to the crosslinker.

A method for forming a glucose limiting layer for a continuous biological sensor includes applying a first solution to a substrate for the continuous biological sensor. The first solution includes PDMS crosslinked with a hydrophilic component to form a first layer on the substrate. The hydrophilic component includes polyethylene oxide repeating units. A second solution is applied onto the first layer. The second solution includes PDMS and a crosslinker to form a second layer on the first layer. The substrate is exposed to an initiator thereby crosslinking the first layer to the second layer in situ.

The glucose limiting layer for a continuous biological sensor includes a substrate. A first layer is on the substrate and includes PDMS crosslinked with a hydrophilic component. The hydrophilic component includes polyethylene oxide repeating units. A second layer is on the first layer, and the second layer includes PDMS. The first layer is crosslinked to the second layer.

A method for forming a glucose limiting layer for a continuous biological sensor includes applying a first solution to a substrate for the continuous biological sensor. The first solution includes PDMS crosslinked with a hydrophilic component to form a first layer on the substrate. The hydrophilic component includes polythiourea. A second solution is applied onto the first layer. The second solution includes PDMS and a crosslinker to form a second layer on the first layer. The substrate is exposed to an initiator thereby crosslinking the first layer to the second layer in situ.

The glucose limiting layer for a continuous biological sensor includes a substrate. A first layer is on the substrate and includes PDMS crosslinked with a hydrophilic component. The hydrophilic component includes polythiourea. A second layer is on the first layer, and the second layer includes PDMS. The first layer is crosslinked to the second layer.

A method for forming a glucose limiting layer for a continuous biological sensor includes applying a first solution to a substrate for the continuous biological sensor to form a first layer on the substrate. The first solution includes PDMS crosslinked with an acrylamide-based material. An agent is applied over the first layer, and the agent includes silane. The substrate is exposed to an initiator thereby bonding the first layer to the agent. A second solution is applied onto the agent to form a second layer. The second solution includes PDMS.

A glucose limiting layer for a continuous biological sensor includes a substrate for a continuous biological sensor. A first layer is on the substrate. The first layer includes PDMS crosslinked with an acrylamide-based material. A second layer is on the first layer. The second layer includes PDMS. An agent is positioned between the first layer and the second layer. The agent includes silane and reacts with the first layer and the second layer to form covalent bonds between the first layer and the second layer.

### BRIEF DESCRIPTION OF THE DRAWINGS

FIG. 1 is a not-to-scale, longitudinal cross-sectional diagram of a working electrode and a reference electrode of a sensor, in accordance with some aspects.

FIG. 2 is a schematic of a glucose limiting layer, in accordance with some aspects.

FIG. 3 is a schematic of formulations of a glucose limiting layer, in accordance with some aspects.

FIG. 4 is a flowchart of a method for forming a glucose limiting layer for a continuous biological sensor, in accordance with some aspects.

FIG. 5 is a schematic of a glucose limiting layer, in accordance with some aspects.

FIG. 6 is a schematic of formulations of a glucose limiting layer, in accordance with some aspects.

FIG. 7 is a flowchart of a method for forming a glucose limiting layer for a continuous biological sensor, in accordance with some aspects.

FIG. 8 is a schematic of a glucose limiting layer, in accordance with some aspects.

FIG. 9 is a schematic of formulations of a glucose limiting layer, in accordance with some aspects.

FIG. 10 is a flowchart of a method for forming a glucose limiting layer for a continuous biological sensor, in accordance with some aspects.

### DETAILED DESCRIPTION

CGMs are crucial for managing conditions like diabetes by providing real-time glucose monitoring. These systems typically use a working electrode and a reference electrode to detect analyte concentrations through electrochemical reactions. Enzyme-based sensors, which commonly employ enzymes like glucose oxidase to catalyze glucose reactions, have some limitations including enzyme instability, signal drift, and interference from other compounds, reducing sensor accuracy and longevity. These issues have prompted the exploration of alternative sensing chemistries to improve the reliability and performance of CGM devices.

Using biocompatible materials in CGM manufacture is one way to improve sensor performance by limiting degradation in vivo and thereby extending functional life of the CGM. Still, there remains a need to further improve the durability, sensitivity, and biocompatibility of glucose limiting layers in continuous biological sensors. Enhancing these properties will lead to more reliable long-term sensor performance, minimizing signal degradation and ensuring more consistent glucose measurements in vivo.

In some aspects herein, the glucose limiting layer is formed from two distinct compounds that interact to produce a single integrated membrane. In some examples, a first compound is crosslinked and then reacts with a second compound in the presence of a crosslinker, resulting in an interwoven structure within the glucose limiting layer. This approach enables formation of a chemically intertwined network in the final membrane, which can improve mechanical stability, layer uniformity, and functional performance of the sensor.

Silicones are widely used in continuous biological sensors, such as CGM sensors, due to their biocompatibility, flexibility, and chemical stability. These materials provide a protective barrier that helps maintain sensor performance while allowing for gas and moisture permeability. In other sensor applications, silicones have been used as encapsulants, adhesives, or as coatings to protect sensitive electronic components and enzymatic sensor elements from degradation caused by external factors such as body fluids and mechanical stress. Their hydrophobic nature also helps to prevent unwanted biofouling, which can impact sensor accuracy over time. The selection of a suitable silicone formulation depends on several factors including permeability, adhesion, and durability to ensure long-term in vivo performance.

Polydimethylsiloxane (PDMS) is a widely used silicone-based polymer known for its flexibility, chemical stability, and biocompatibility. Structurally, PDMS consists of repeating siloxane (—Si—O—Si—) units with methyl (—CH₃) side groups, imparting hydrophobicity and thermal resistance. PDMS can be synthesized as a linear polymer or crosslinked into an elastomeric network, depending on the application. Methods of crosslinking include platinum-catalyzed hydrosilylation reactions, condensation curing, and peroxide curing, each offering different mechanical and chemical properties.

In the present disclosure, PDMS is uniquely formulated in a glucose limiting layer in a continuous biological sensor due to its high biocompatibility, tunable permeability, and chemical stability. The glucose limiting layer regulates the diffusion of glucose to the enzyme layer, ensuring a controlled and consistent reaction with the immobilized GOx enzyme. By adjusting the porosity, thickness, and hydrophobicity, the PDMS can be optimized to balance glucose diffusion, prevent sensor saturation and improve accuracy over an extended use timeframe. Additionally, PDMS resists biofouling and can endure ethylene oxide (EtO) sterilization, making it an ideal material for implantable or long-term wear sensors. Its flexibility and durability allow it to conform to miniaturized sensor designs, thus ensuring consistent performance in interstitial fluid environments.

Finally, PDMS is highly biocompatible, as the human body treats silicone-based materials with less hostility than it does with some other implantable materials. The silicone membranes of the present disclosure possess unique permeability properties that selectively allow water transfer while rejecting hydrogen peroxide. This selective permeability enhances sensor accuracy by preventing interference from hydrogen peroxide byproducts.

Vinyl-terminated PDMS is a PDMS material in which vinyl-functional groups are provided at terminal positions of the PDMS polymer chains, thereby providing reactive sites that enable controlled crosslinking to form an elastomeric silicone network. In some aspects, vinyl-terminated PDMS is combined with a crosslinker that includes silicon hydride functionality, and a catalyst that includes platinum, to form a crosslinked membrane via an additional cure reaction on the substrate. In such aspects, the vinyl-terminated PDMS can be selected with a molecular weight to control solution viscosity, coating behavior, and the elastic modulus of the resulting glucose limiting layer. In further examples, the formulation can optionally include one or more additives, such as a hydrophilic additive having polyethylene oxide repeating units and/or a reinforcer such as fumed silica or a silicone resin, to tune water transport, mechanical durability, and permeability characteristics of the glucose limiting layer for continuous biological sensor operation.

In the fabrication of silicone membranes, crosslinking is a process that transforms liquid silicone precursors into solid, durable structures by forming covalent bonds between polymer chains, resulting in a three-dimensional network. In this context, crosslinking refers to the process of the formation of covalent or ionic bonding between adjacent polymer backbones creating an interconnected three-dimensional structure. This crosslinking can be initiated through various mechanisms, including light-based initiation, humidity-based initiation, heat-based initiation, and catalyst-based initiation.

In light-based initiation, photoinitiators are utilized and crosslinking can be triggered by exposure to specific wavelengths of light, typically ultraviolet (UV) light. This method allows for spatial and temporal control over the curing process, enabling precise patterning and structuring of the silicone material. For instance, UV radiation can initiate free-radical reactions in silicone formulations containing appropriate photoinitiators, leading to rapid curing at ambient temperatures.

In humidity-based initiation, moisture in the environment triggers hydrolysis and subsequent condensation reactions within moisture-curable silicone systems. This process is often catalyzed by tin, titanium, or amine compounds and enables curing at room temperature without the need for external heat or light, making it suitable for ambient condition applications.

In heat-based initiation, thermal curing involves the application of heat to activate a curing agent or catalyst within the silicone mixture. A common approach is the use of peroxide initiators, such as dicumyl peroxide, which decomposes upon heating to generate free radicals that facilitate crosslinking. This method is effective in achieving uniform curing throughout the material.

In catalyst-based initiation, catalytic systems, such as those involving platinum-based catalysts, peroxides or mediators, are employed to promote crosslinking reactions at lower temperatures. In one example, such as hydrosilylation reactions, a platinum catalyst facilitates the addition of silicon-hydrogen (Si—H) bonds across carbon-carbon double bonds (C═C), resulting in a crosslinked silicone network.

In aspects disclosed herein, the glucose limiting layer involves two distinct polymerization systems that are combined and subsequently crosslinked to form an intertwined crosslinked network in situ. This structure consists of a first compound crosslinked with a second compound creating a robust and stable matrix. This approach ensures a controlled and uniform crosslinking reaction, enhancing mechanical integrity, chemical stability, and performance consistency. The two compounds can undergo both intra- and inter-crosslinking, resulting in an integrated network. This approach allows for compatibilization of disparate chemistries and/or morphologies, offering enhanced mechanical stability, durability, and uniformity within the final structure. The resulting glucose limiting layer may possess optimized properties far greater than the just the sum of the crosslinkable parts, such as tunable permeability and diffusivity with unparalleled durability.

In some aspects of this disclosure, the glucose limiting layer is not formed as a separate membrane that is later laminated or attached to a sensor, but is instead formed directly on the substrate by in situ polymerization and/or crosslinking of one or more applied coating solutions. In other words, the coating can be applied as a liquid or flowable solution and then converted into the final network after it has leveled and conformed to the substrate, such as through dip coating followed by a post dip activation step that initiates polymerization and/or crosslinking, with the apply and activate cycle optionally repeated to build to a target thickness.

In situ polymerization enables formation of a glucose limiting layer that is both thickness controlled and performance consistent. Historically, silicone-based materials, including PDMS and PDMS derivatives, have not been used to form resistive glucose limiting layers of controlled thickness because typical PDMS materials are provided as relatively low molecular weight species that do not readily build chain length or membrane thickness when applied as coatings. As a result, silicone materials have traditionally been limited to ultra-thin coatings or used only as minor additives within other membrane systems, rather than as the primary resistive component. These ultra-thin silicone layers are insufficient to provide the controlled diffusional resistance required for glucose limiting functionality in continuous biological sensors, leading those skilled in the art to avoid silicone-dominant membranes formed in situ for this purpose.

Additionally, prior attempts to incorporate hydrophilic functionality into silicone systems have been viewed as inherently difficult to control due to the strong hydrophobic nature of silicone matrices. Conventional dispersions of hydrophilic additives within silicone tend to form discontinuous domains or isolated pockets rather than continuous transport pathways, resulting in inconsistent sensor performance and poor reproducibility. In contrast, aspects of the present disclosure address this technical challenge by first building hydrophilic silicone monomers to a predetermined molecular weight prior to in situ polymerization on the substrate. By increasing the molecular weight of silicone monomers that include hydrophilic moieties, such as polyethylene oxide repeating units, the number and spacing of hydrophilic repeating units can be precisely controlled. This approach enables formation of continuous and tunable water transport channels within the crosslinked silicone network, while still allowing the membrane to be deposited and cured in situ to a controlled thickness. The subsequent crosslinking step locks in the transport properties of the glucose limiting layer, preventing hydration induced drift and ensuring that the membrane performance remains substantially fixed from initial calibration through in vivo operation.

In some aspects, the glucose limiting layer is designed to partially reject glucose, necessitating a highly crosslinked network to regulate glucose permeability. A high silicone content is incorporated due to its favorable biocompatibility within biological environments. The surface characteristics of silicone inherently reduce the adhesion of basement membrane proteins, thereby minimizing biofouling and the potential for an immune response. This property translates to enhanced longevity and stability of the system.

In some aspects, PDMS serves as the hydrophobic component of the system, contributing to its extended longevity in biological environments. The high surface energy of PDMS inhibits protein adhesion and biofilm formation, making it particularly suitable for implantable biomedical applications. In typical biofilm formation, biologic materials deposit onto a surface where they can physically adhere to it, even in the absence of covalent bonding. However, due to the inherently hydrophobic nature of PDMS, its surface energy is too high to allow for protein interaction or stable biofouling, preventing the attachment of biological debris and discouraging biofilm formation.

In some aspects, the glucose limiting layer disclosed herein offers advantages that contribute to improved sensor longevity and stability. Conventional urethane-based membranes typically demonstrate effective glucose permeability for approximately 10 days before experiencing performance degradation. In contrast, silicone membranes have the potential for significantly longer operational lifespans until the hydrophilic components are cleaved by the body. Polythioureas provide an alternative solution to silicone membranes in some aspects, as they structurally resemble naturally occurring urea, which the body does not recognize as foreign nor actively degrade. Additionally, a crosslinked system enables precise control over composition and thickness of the layer, resulting in a fixed sensitivity that (should) remain consistent over time.

Additionally, silane incorporated in a silicone-based glucose limiting layer may function as a bonding or coupling agent based on the “like-like-like” principle. By serving as an interfacial linker, silane facilitates adhesion between multiple layers within the glucose limiting layer. This interfacial reaction enhances bond strength, mitigates delamination, and helps improve overall sensor stability.

Once the glucose limiting layer is fabricated (e.g., crosslinking completed) and its sensitivity measured, that sensitivity is expected to remain stable over the functional lifespan of the sensor, or until complete degradation occurs. When placed in vivo, minor sensitivity decline may occur due to limited biofilm formation or protein adsorption on the surface, leading to slightly hindered analyte diffusion. However, the ability of the crosslinked compounds to maintain long-term glucose permeability with minimal sensitivity loss is superior to that of polyurethane-based membranes and aims to raise the bar in performance for continuous biological sensors.

In some aspects, optionally, at least one of the first compound or the second compound further comprises a reinforcer. The reinforcer may be dispersed in a solution before application to the substrate and remains incorporated within the resulting glucose limiting layer to improve mechanical durability in vivo, including resistance to tearing, abrasion, and creep, while maintaining a diffusion profile that is primarily tuned by thickness, crosslink density, and the presence of hydrophilic components. In some examples, the reinforcer comprises fumed silica. In other examples, the reinforcer comprises a silicone resin, such as trimethylsiloxysilicate silicone resin (MQ silicone resin) and/or a vinyl-functional silicone resin, selected and used in an amount that increases toughness without making the glucose limiting layer overly stiff, since increased modulus can increase the likelihood of cracking in very thin films under repeated bending.

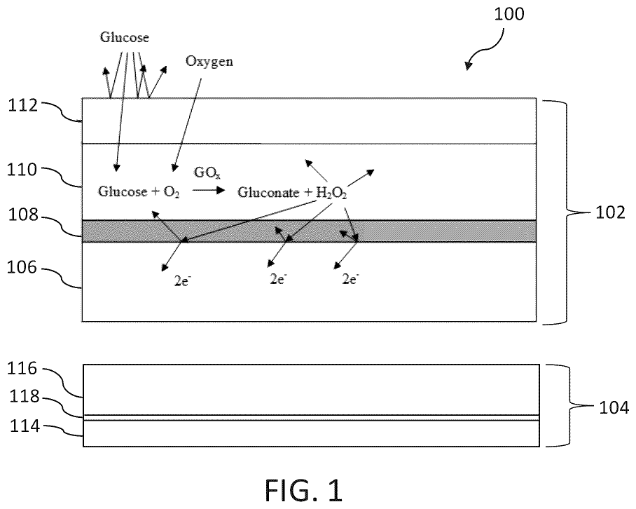

FIG. 1 is a not-to-scale, longitudinal cross-sectional diagram of a working electrode and a reference electrode of a sensor, in accordance with some aspects. A sensor 100 for a continuous biological monitor such as a CGM has a working electrode 102 which cooperates with a reference electrode 104 to provide an electrochemical reaction that can be used to determine glucose levels in a fluid of a patient, such as blood or interstitial fluid. Although the sensor 100 is illustrated with one working electrode 102 and one reference electrode 104, it will be understood that some alternative sensors may use multiple working electrodes, multiple reference electrodes, and counter electrodes. It will also be understood that sensor 100 may have different physical relationships between the working electrode 102 and the reference electrode 104. For example, the working electrode 102 and the reference electrode 104 may be arranged in layers, spiraled, or side-by-side. It will be understood that many other physical arrangements may be consistent with the disclosure herein.

The working electrode 102 may comprise a conductive substrate 106 (which in this example is a conductive wire 106), an interference layer 108, an enzyme layer 110 and a glucose limiting layer 112. The working electrode 102 has a conductive portion, which is illustrated for sensor 100 as conductive wire 106. The conductive wire 106 can be, for example, solid platinum, a platinum coating on a less expensive metal or plastic, or a conductive carbon-based compound coating on a plastic substrate. It will be understood that other electron conductors may be used consistent with this disclosure. The working electrode 102 has the glucose limiting layer 112, which may be used to limit not only the amount of glucose that reaches the enzyme layer 110, but also may serve to restrict contaminants/interferents from passing through.

The enzyme layer 110 comprises an enzyme for reacting with in vivo glucose in body fluid of a patient. In operation, the glucose limiting layer 112 substantially limits the amount of glucose that can reach the enzyme layer 110, for example only allowing about 1 of 1000 glucose molecules to pass. By strictly limiting the amount of glucose that can reach the enzyme layer 110, linearity of the overall response is improved. The glucose limiting layer 112 also permits oxygen to travel to the enzyme layer 110. Typically, the enzyme layer 110 has one or more glucose oxidase enzymes dispersed within the enzyme layer 110. When a molecule of glucose and a molecule of oxygen (O₂) are combined in the presence of the glucose oxidase, a molecule of gluconate and a molecule of hydrogen peroxide (H₂O₂) are formed. The hydrogen peroxide then generally disperses both within the enzyme layer 110 and into the interference layer 108.

In some aspects, optionally, the interference layer 108 is layered between the conductive wire 106 and the enzyme layer 110 in the working electrode 102. The interference layer 108 can be uniquely formulated to have a more precise regulation, compared to conventional insulating layers, of the level of hydrogen peroxide molecules that are enabled to pass from the enzyme layer 110 to a more expansive surface area of the conductive wire 106. The interference layer 108 may be electrodeposited onto the conductive wire 106 in a very consistent and conformal way, thus reducing manufacturing costs as well as providing a more controllable and repeatable layer formation. The interference layer 108 is nonconducting of electrons, but will pass negative ions at a preselected rate. Further, the interference layer 108 may be formulated to be permselective toward certain molecules. In one example, the interference layer 108 is formulated and deposited in a way to restrict the passage of larger molecules, that may function as contaminants which could degrade the conductive wire 106, or which could interfere with the electrical detection and transmission processes.

In some aspects, the interference layer 108 may be constructed using, for example, poly-ortho-aminophenol (POAP, or poly(o-aminophenol)), polypyrrole, polyaniline, and/or poly(phenylenediamine). For example, a polymer made of monomers selected from aminophenols, aniline, phenylenediamine, pyrrole or combinations thereof may be used in interference layer 108. In a specific example, the interference layer may include pyrrole and phenylenediamine. It will be understood that other materials may be used. For example, the interference layer 108 may include a polymer that has been electropolymerized from: aniline, naphthol, phenylenediamine, 2-aminophenol, 3-aminophenol, 4-aminophenol, m-phenylenediamine, o-phenylenediamine, p-phenylenediamine, pyrrole, derivatized pyrrole, aminophenylboronic acid, thiophene, porphyrin, phenol, or thiophenol or blends thereof.

The sensor 100 has a reference electrode 104 separate from working electrode 102. In this way, the manufacture of the working electrode 102 is simplified and can be performed with a consistency that contributes to dramatically improved stability and performance. The reference electrode 104 comprises a reference substrate which is illustrated as reference wire 114, and an ion limiting layer 116. A paste 118 comprising silver/silver chloride (Ag/AgCl) or iridium oxide may be applied to the reference wire 114 of the reference electrode 104. The ion limiting layer 116 may be over the paste 118. The application of the ion limiting layer 116 over the paste 118 desirably controls the electrical current sensitivity of the overall sensor 100 by controlling the flow of ions from the paste 118. In this way, current sensitivity may be advantageously controlled and defined. As will be understood, this can also act as a secondary method to control sensor sensitivity by controlling the chloride release from the reference electrode 104. In some examples, the ion limiting layer 116 of the reference electrode 104 may be selected from polyurethane, cellulosic, polyvinyl chloride (PVC) or combinations thereof.

In operation, the glucose limiting layer 112 substantially limits the amount of glucose that can reach the enzyme layer 110. The glucose limiting layer 112 is constructed to provide a thin conformal layer of a crosslinked material that is easy to apply and that provides exceptional uniformity, glucose diffusion control, and linearity results.

### EXAMPLE 1

### Glucose Limiting Layer With (PDMS+Polyethylene Oxide Repeating Units)+(PDMS+Crosslinker)

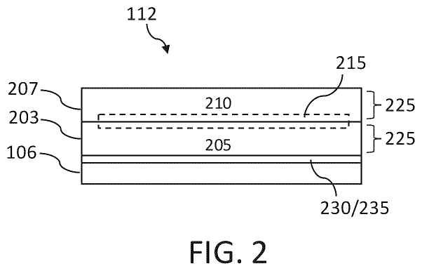

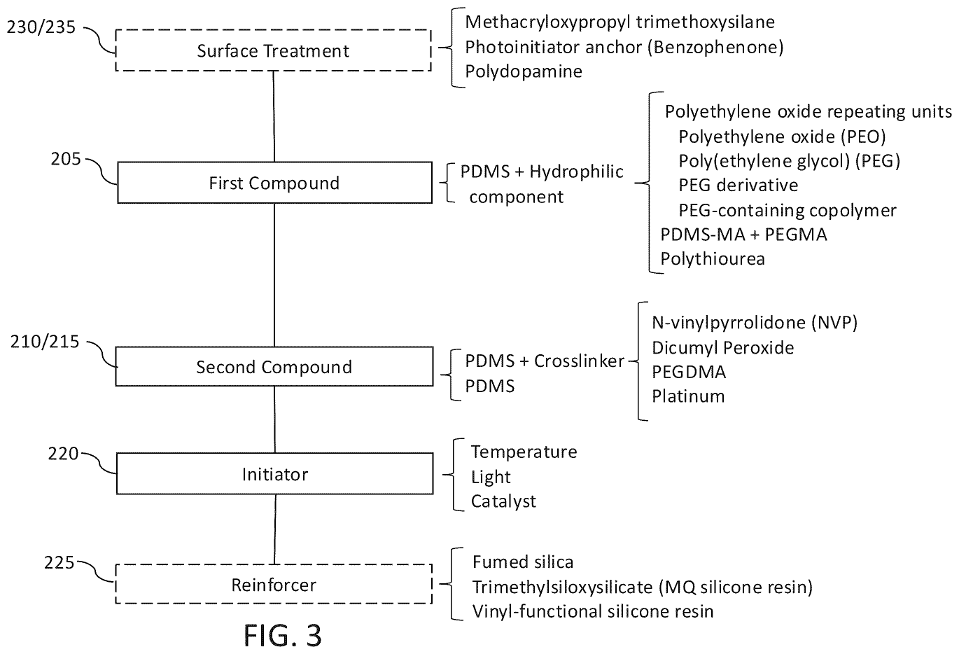

FIG. 2 is a schematic of a glucose limiting layer, and FIG. 3 is a schematic of formulations of a glucose limiting layer, both in accordance with some aspects. In some examples, the glucose limiting layer 112 for the sensor 100 includes a substrate 106, a first layer 203 having a first compound 205 and a second layer 207 having a second compound 210. In this disclosure, a “solution” refers to a liquid or flowable coating composition that is applied to the substrate or to an underlying layer. A “compound” refers to the resulting material of a layer after the applied solution has undergone polymerization and/or crosslinking, for example during a post application activation step. Thus, the first compound 205 of the first layer 203 can be formed from a first solution applied to the substrate, and the second compound 210 of the second layer 207 can be formed from a second solution applied onto the first layer.

The first compound 205 includes PDMS crosslinked with a hydrophilic compound. The hydrophilic compound includes polyethylene oxide repeating units in this example, and may be selected from polyethylene oxide (PEO), poly(ethylene glycol) (PEG), a PEG derivative, or a PEG-containing copolymer. The second compound 210 includes silicone such as PDMS and a crosslinker 215. The crosslinker 215 may be utilized to, in some aspects, crosslink compounds and/or layers together, or in other aspects, to bond compounds and/or layers together. Bonding (see Example 3) refers to the process to enhance the bond strength between two surfaces by modifying their interfacial properties. Unlike crosslinking, which involves covalent bonding within a material, bonding (also referred to as coupling) functions at the interface between different materials, improving adhesion by increasing surface compatibility or introducing functional groups that interact with both surfaces through non-covalent, hydrogen bonding or van der Waals interactions.

In some examples, the crosslinker 215 may be included in the first compound 205, the second compound 210, or both the first compound 205 and the second compound 210. The crosslinker 215, a crosslinking agent, facilitates crosslinking the first compound 205 and the second compound 210, each of which may be already crosslinked internally. In some examples, the crosslinker 215 is dicumyl peroxide or polyethylene glycol dimethacrylate (PEGDMA). These react with an initiator (e.g., heat, light or catalyst) and may be consumed during the reaction.

In one example, the crosslinker 215 comprises dicumyl peroxide. Dicumyl peroxide can function as a peroxide-based free radical source that, upon thermal activation, decomposes to generate free radicals that initiate polymerization and crosslinking of the compounds and/or layers. In some examples, heat is applied to the substrate at which the dicumyl peroxide breaks down and initiates a free radical chain reaction that crosslinks the first layer 203 to the second layer 207 in situ. In this manner, dicumyl peroxide can serve as the crosslinker 215 that helps initiate the reaction and is consumed during formation of the crosslinked network that bonds the first layer 203 to the second layer 207.

In FIG. 2, the crosslinker 215 is shown in broken lines to indicate that it is consumed. To initiate the crosslinking process, an initiator 220 (FIG. 3) may be applied to the reaction. In some aspects, the initiator 220 is temperature, light or a catalyst. In this example, the initiator 220 is temperature such that heat is applied to cleave the dicumyl peroxide, generating free radicals that promote polymerization. For example, when dicumyl peroxide is heated to approximately 60° to 80° Celsius, it decomposes into reactive peroxide species, triggering a chain reaction that induces crosslinking. The resulting glucose limiting layer 112 provides controlled glucose diffusion, enhanced oxygen permeability, and durability, making it suitable for the sensor 100. Dicumyl peroxide is an effective crosslinker 215 for dip-coated polymer systems as it facilitates low-viscosity processing, allowing for uniform film formation and controlled crosslinking without premature gelation.

In some aspects, the glucose limiting layer 112 for a continuous biological sensor 100 includes a substrate 106. A first layer 203 is on the substrate 106 and includes PDMS crosslinked with a hydrophilic component. The hydrophilic component includes polyethylene oxide repeating units. A second layer 207 is on the first layer 203, and the second layer 207 includes PDMS. The first layer 203 is crosslinked to the second layer 207.

In some aspects, the PDMS of the second compound may be at least 40% by weight and the other constituents are appropriately balanced. In some aspects, the concentration of dicumyl peroxide (e.g., crosslinker 215) ranges from 9% to 11%, or 10% by weight.

In some aspects, N-vinylpyrrolidone (NVP) may be used as a dual-function crosslinking agent to facilitate bonding between the first compound 205 and the second compound 210 within the glucose limiting layer 112. NVP contains a vinyl group capable of undergoing free-radical polymerization, and a lactam ring that provides hydrophilic character and enhances interfacial compatibility. This dual functionality enables NVP to participate in crosslinking reactions with both hydrophilic components, such as polyethylene oxide repeating units in the first compound 205, and hydrophobic silicone networks, such as PDMS in the second compound 210. When used in conjunction with an initiator 220, such as heat or UV light, NVP can form covalent bonds across the interface of the two pre-crosslinked layers, enhancing mechanical integrity and reducing delamination. Moreover, NVP's hydrophilicity may further improve glucose permeability while maintaining oxygen diffusion properties, contributing to the overall performance of the glucose limiting layer 112 in sensor 100.

In some aspects, the PDMS crosslinked with the hydrophilic component is formed from methacrylated polydimethylsiloxane (PDMS-MA) and polyethylene glycol methacrylate (PEGMA), where PDMS-MA provides silicone segments that copolymerize into an elastomeric network and PEGMA provides polyethylene glycol content that increases water uptake and can improve glucose permeability. In this context, adding polyethylene glycol dimethacrylate (PEGDMA) as a crosslinker can further bias the network toward more hydrophilic crosslinks, which tends to promote PEG-rich transport pathways within the silicone matrix, supporting higher water transport while maintaining a silicone-based membrane structure.

Dip coating involves sequential deposition and curing steps to achieve a uniform, multi-layered polymer coating. Methods for coating a wire for a continuous biological sensor by dipping (e.g., dip coating) are described in U.S. Pat. No. 12,087,469, which is assigned in common with the present application and is incorporated by reference in its entirety as though fully set forth herein. During dip coating, the substrate is dipped into a first solution and withdrawn, optionally dipped into a second solution or additional solutions and withdrawn after each dip, and then subjected to a post dip activation step that initiates polymerization and/or crosslinking, such as exposure to heat in a thermal tunnel. The post dip activation may be after each dip or after multiple dips.

The dip/heat tunnel/cure cycle may be repeated multiple times to achieve the desired coating thickness, or target thickness, and uniformity. Alternatively, for light-curable materials, such as acrylamides and other photopolymerizable systems, a UV light source can be applied immediately after the coating step. For example, upon removal from the dip solution, the substrate may be exposed to UV light for a short duration, such as five seconds, to initiate rapid polymerization and crosslinking. The specific curing mechanism, whether thermal, UV, or alternative triggering methods, can be tailored based on the chemical composition of the coating system, including the presence of additives or photoinitiators, allowing for precise control over film formation and material properties.

In some examples, optionally, at least one of the first compound 205 or the second compound 210 further comprises a reinforcer 225. The reinforcer 225 is dispersed in the compound before application to the substrate and it remains incorporated within the resulting glucose limiting layer 112. The reinforcer 225 may be selected to improve mechanical durability of a thin silicone-based coating in vivo, including improving resistance to tearing, abrasion, and creep, while maintaining a diffusion profile that is primarily tuned by thickness, crosslink density, and the presence of hydrophilic components. In some examples, the reinforcer 225 comprises fumed silica, which can act as a reinforcing particulate phase within the silicone network to increase tear strength and reduce creep of the glucose limiting layer 112 under flexing and handling, while allowing the glucose limiting layer 112 to remain elastomeric when used at moderate amounts.

In some examples, the reinforcer 225 may comprise a silicone resin that functions as a reinforcing phase within the silicone network. For example, the reinforcer can comprise trimethylsiloxysilicate silicone resin, also referred to as MQ silicone resin, and/or a vinyl-functional silicone resin. In such examples, the resin can be viewed as a pre-polymerized reinforcing component that is blended into the solution with the silicone constituents to increase toughness and abrasion resistance of the resulting layer and, in some formulations, to reduce permeability relative to a softer elastomeric network at the same thickness. In some examples, the resin is selected and used in an amount that increases toughness without making the glucose limiting layer 112 overly stiff, since increased modulus can increase the likelihood of cracking in very thin films under repeated bending. In some examples, the amount of the resin may be 2% to 5% by weight.

In some aspects, the initiator 220 may be a catalyst. For example, a platinum-catalyzed addition cure system may be used to crosslink the first compound 205 and the second compound 210 instead of the dicumyl peroxide, such as in a room-temperature vulcanizing (RTV) reaction.

In some examples, at least one of the first solution used to form the first compound 205 and/or the second solution used to form the second compound 210 further comprises platinum as a catalyst, so that the platinum catalyst is present during the post application activation step and promotes curing and/or crosslinking.

In some examples, a surface treatment such as a primer layer or preliminary layer may be included. A primer layer 230 may be formed on a surface of the substrate 106 prior to forming the first layer 203 and the second layer 207. In some examples, the primer layer 230 may comprise polydopamine or methacryloxypropyl trimethoxysilane. The primer layer 230 may improve wetting of the substrate 106 by the subsequently applied solution and can increase adhesion of the resulting glucose limiting layer 112 to the substrate 106. Polydopamine may be provided as a thin coating on the substrate 106 prior to applying the first solution, and the first solution and/or second solution can then be applied over the primer layer 230 and subjected to a post application activation step. In such examples, the primer layer 230 may reduce delamination of a silicone-based coating from the substrate 106 during handling or in vivo use, including reducing a condition in which the coating separates from the substrate 106 and can slide relative to the substrate 106.

Similarly, prior to forming the first layer 203 and the second layer 207, the substrate 106 may be coated with a preliminary composition to form a preliminary layer 235. The preliminary composition may comprise a photoinitiator anchor that is retained at or near the surface of the substrate 106. The preliminary composition is exposed to light to initiate an in situ reaction on the substrate 106 to form a preliminary layer 235. In some examples, the photoinitiator anchor comprises benzophenone. Upon exposure to light, reactive species are generated at the substrate surface so that subsequent polymerization can be initiated from the surface during application and activation of the first solution and/or the second solution. This surface-initiated attachment can increase adhesion of the glucose limiting layer 112 to the substrate 106 and reduce delamination in use, including reducing a condition in which a membrane layer separates from the substrate 106 and can slide relative to the substrate 106.

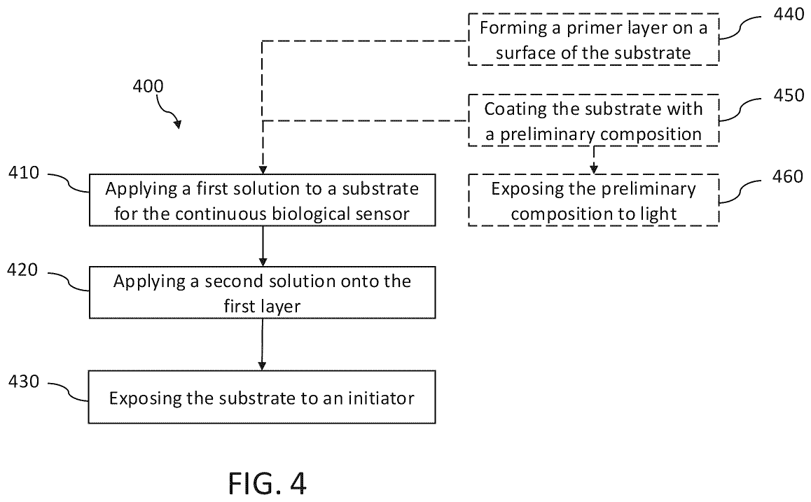

FIG. 4 is a flowchart of a method for forming a glucose limiting layer for a continuous biological sensor, in accordance with some aspects. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

A method 400 for forming a glucose limiting layer for a continuous biological sensor 100 starts at block 410 by applying a first solution to a substrate for the continuous biological sensor 100. The first solution comprises PDMS crosslinked with a hydrophilic component to form a first layer on the substrate. The hydrophilic component comprises polyethylene oxide repeating units, and the hydrophilic component is selected from polyethylene oxide (PEO), poly(ethylene glycol) (PEG), a PEG derivative, or a PEG-containing copolymer. In some examples, the applying the first solution comprises dip coating the substrate.

At block 420, a second solution is applied onto the first layer. The second solution comprises PDMS and a crosslinker to form a second layer on the first layer. In some examples, the crosslinker of the second solution comprises dicumyl peroxide or polyethylene glycol dimethacrylate (PEGDMA). In some examples, the applying the second solution comprises dip coating the substrate.

In some examples, the first solution further comprises a crosslinker. The crosslinker may comprise dicumyl peroxide or polyethylene glycol dimethacrylate (PEGDMA). In such examples, the crosslinker in the first solution can remain substantially inactive during dip coating of the first solution and may be activated during a post dip activation step, such as exposure to heat, light, or a catalyst. In some examples, activation of the crosslinker promotes formation of a crosslinked network within the first layer and also promotes interlayer crosslinking between the first layer and the second layer when the second layer is subsequently applied. The post dip activation step may be performed after applying the first solution, after applying the second solution, or after multiple application cycles, depending on the desired thickness and processing sequence.

At block 430, the substrate is exposed to an initiator thereby crosslinking the first layer to the second layer in situ. In some examples, the initiator comprises heat or light to activate the crosslinker. The method 400 is repeated (e.g., blocks 410, 420 and 430) such as the applying the first solution, the applying the second solution and the exposing the substrate to the initiator to increase a thickness of the glucose limiting layer. In some scenarios, the thickness of the glucose limiting layer is 12 microns to 20 microns.

Before blocks 410-430, optionally, at block 440, a primer layer may be formed on a surface of the substrate. This may improve wetting of the substrate by subsequently applied solutions and increase adhesion of the glucose limiting layer to the substrate to reduce delamination. The primer layer may comprise polydopamine or methacryloxypropyl trimethoxysilane.

Before blocks 410-430, optionally, at block 450, the substrate may be coated with a preliminary composition. The preliminary composition may comprise a photoinitiator anchor. This may promote surface-initiated attachment of subsequently applied layers to increase adhesion to the substrate and reduce delamination. At block 460, the preliminary composition is exposed to light to initiate an in situ reaction on the substrate to form a preliminary layer 235. In some examples, the photoinitiator anchor comprises benzophenone.

### EXAMPLE 2

### Glucose Limiting Layer With (PDMS+Polythiourea)+(PDMS+Crosslinker)

Polythiourea is a class of polymers characterized by thiourea (—NH—C(S)—NH—) linkages in its backbone, offering enhanced stability and biocompatibility compared to traditional polyureas. Unlike polyurethanes, which can degrade over time in biological environments, polythiourea is more resistant to enzymatic and hydrolytic cleavage due to its structural similarity to naturally occurring urea, a compound readily processed by the body. It was recognized in relation to this disclosure that inherent stability makes polythiourea particularly advantageous for biomedical applications, including glucose limiting layers in CGM sensors. In CGM sensors, polythiourea may be included in the glucose limiting layer, controlling glucose diffusion to the enzyme reaction site while maintaining long-term performance. Unlike other hydrophilic polymers which the body tends to degrade over time, polythiourea remains chemically stable and functionally intact, reducing sensor drift and performance degradation. Additionally, its tunable crosslinking density allows precise control over glucose permeability, enabling consistent sensor sensitivity throughout its lifespan.

These polythiourea polymers possess dynamic thiourea bonds, which enable them to autonomously reorganize and repair damage when subjected to appropriate environmental conditions. For instance, when a polythiourea-based material is cut or scratched, the dynamic nature of the thiourea linkages allows the polymer chains to realign and reform, effectively “sealing” the wound over time.

Referring to FIGS. 2 and 3, in some aspects, a glucose limiting layer 112 for a continuous biological sensor 100 includes a first layer 203 having a first compound 205, and a second layer 207 having a second compound 210. The first compound 205 of the first layer 203 can be formed from a first solution applied to the substrate, and the second compound 210 of the second layer 207 can be formed from a second solution applied onto the first layer.

The first compound 205 includes PDMS crosslinked with a hydrophilic component such as polythiourea. The second compound 210 includes a silicone-based material, such as PDMS and a crosslinker 215. In this example, the crosslinker 215 is a crosslinking agent and crosslinks the first compound 205 and the second compound 210, each of which may already be crosslinked internally. In some examples, the crosslinker 215 may be dicumyl peroxide or polyethylene glycol dimethacrylate (PEGDMA). In this example, the crosslinker 215 is dicumyl peroxide which crosslinks the first compound 205 and the second compound 210, and may be consumed during the reaction. In some examples, the first solution may also include a crosslinker 215. To initiate the crosslinking process, an initiator 220 may be applied to the reaction. In some aspects, the initiator 220 is temperature, light or a catalyst. In this example, the initiator 220 is temperature, such that heat is applied to cleave the dicumyl peroxide generating free radicals that facilitate polymerization.

In some examples, at least one of the first solution used to form the first compound 205 and/or the second solution used to form the second compound 210 further comprises platinum as a catalyst, so that the platinum catalyst is present during the post application activation step and promotes polymerization and/or crosslinking.

In some aspects, a glucose limiting layer 112 for a continuous biological sensor 100 includes a substrate 106 for the continuous biological sensor 100. A first layer 203 is on the substrate 106, the first layer includes PDMS crosslinked with a hydrophilic component. The hydrophilic component includes polythiourea. A second layer 207 is on the first layer 203, and the second layer 207 includes PDMS. The first layer 203 is crosslinked to the second layer 207.

In some aspects, the PDMS of the second compound 210 may be at least 40% by weight and the other constituents are appropriately balanced. In some aspects, the concentration of dicumyl peroxide ranges from 10% by weight.

The polythiourea-based glucose limiting layer 112 enhances sensor longevity and stability. Traditional urethane-based membranes provide effective glucose diffusion control but exhibit degradation after approximately 10 days, severely impacting sensor performance. Silicone based membranes can offer extended operational lifespans, and the extent of long-term stability may depend on the formulation, since certain hydrophilic components may be susceptible to enzymatic cleavage in vivo over time. In contrast, polythiourea provides a more stable alternative due to its structural similarity to naturally occurring urea, which the body does not recognize as foreign nor actively degrade. This improves long-term sensor function by mitigating loss of hydrophilic properties. Additionally, a crosslinked polythiourea network allows control over membrane properties, including glucose permeability and sensor sensitivity. By adjusting the ratio of crosslinking components and membrane thickness, a stable and reproducible sensitivity profile can be achieved, ensuring consistent sensor performance throughout its intended lifespan.

For this polythiourea-based glucose limiting layer 112, the dip coating and post dip activation approaches described herein may likewise be used to apply the first solution and the second solution to form the first layer 203 and the second layer 207. The application cycle may be repeated to reach a target thickness, with the post dip activation (e.g., exposure to the initiator 220) performed after each dip or after multiple dips depending on the selected processing sequence.

As described herein, the polythiourea-based glucose limiting layer 112 may optionally include a reinforcer 225 to improve mechanical durability in vivo. For example, the reinforcer 225 may be included in the first solution and/or the second solution so that the reinforcer 225 remains incorporated within the resulting glucose limiting layer 112. The reinforcer may comprise one or more of a fumed silica, trimethylsiloxysilicate (MQ silicone resin), or a vinyl-functional silicone resin. In addition, the substrate 106 may optionally include surface treatments such as the primer layer 230 and/or the preliminary layer 235, as described herein, to improve adhesion and reduce delamination in the resulting multilayer glucose limiting layer.

The method 400 for forming a glucose limiting layer for a continuous biological sensor 100 as described in FIG. 4 is the same as this example using polythiourea. For example, the method 400 for forming a glucose limiting layer for a continuous biological sensor 100 starts at block 410 by applying a first solution to a substrate for the continuous biological sensor 100. The first solution comprises PDMS crosslinked with a hydrophilic component to form a first layer on the substrate. The hydrophilic component comprises polythiourea. In some examples, the applying the first solution comprises dip coating the substrate.

At block 420, a second solution is applied onto the first layer. The second solution comprises PDMS and a crosslinker to form a second layer on the first layer. In some examples, the crosslinker of the second solution comprises dicumyl peroxide or polyethylene glycol dimethacrylate (PEGDMA). In some examples, the applying the second solution comprises dip coating the substrate.

In some examples, the first solution further comprises a crosslinker. The crosslinker may comprises dicumyl peroxide or polyethylene glycol dimethacrylate (PEGDMA). At block 430, the substrate is exposed to an initiator thereby crosslinking the first layer to the second layer in situ. In some examples, the initiator comprises heat or light to activate the crosslinker. The method 400 is repeated (e.g., blocks 410, 420 and 430) such as the applying the first solution, the applying the second solution and the exposing the substrate to the initiator to increase a thickness of the glucose limiting layer. In some scenarios, the thickness of the glucose limiting layer is 12 microns to 20 microns.

Before blocks 410-430, optionally, at block 440, a primer layer may be formed on a surface of the substrate as described herein, to improve wetting and adhesion and reduce delamination. Similarly, optionally, at block 450, the substrate may be coated with a preliminary composition that includes a photoinitiator anchor, and at block 460, the preliminary composition may be exposed to light to initiate an in situ reaction on the substrate to form a preliminary layer 235, which can promote surface-initiated attachment of subsequently applied layers. In some examples, the photoinitiator anchor comprises benzophenone.

### EXAMPLE 3

### Glucose Limiting Layer With (PDMS+Acrylamide)+PDMS

The glucose limiting layer may be comprised of multiple layers. As such, in multilayer systems, delamination may occur due to inadequate adhesion between the layers. This leads to device failures, reduced accuracy, and limited operational lifespans. Traditional methods to improve adhesion between layers within the glucose limiting layer use materials known as adhesion promoters. These materials are applied at the outermost interface, typically acting as an adhesion-promoting surface treatment for polymeric or metallic substrates and facilitate the attachment of a hydrophilic material onto a non-reactive polymeric or metallic surface. However, in these conventional applications, the adhesion promoter primarily reacts with the incoming material, rather than forming a strong interfacial bond between pre-existing layers. Consequently, these systems fail to effectively resolve delamination issues in multilayer glucose limiting layers.

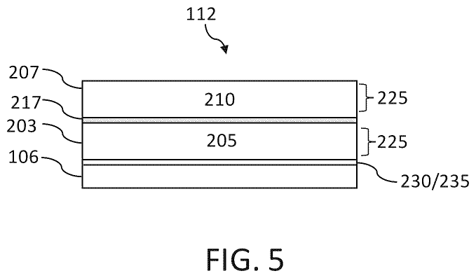

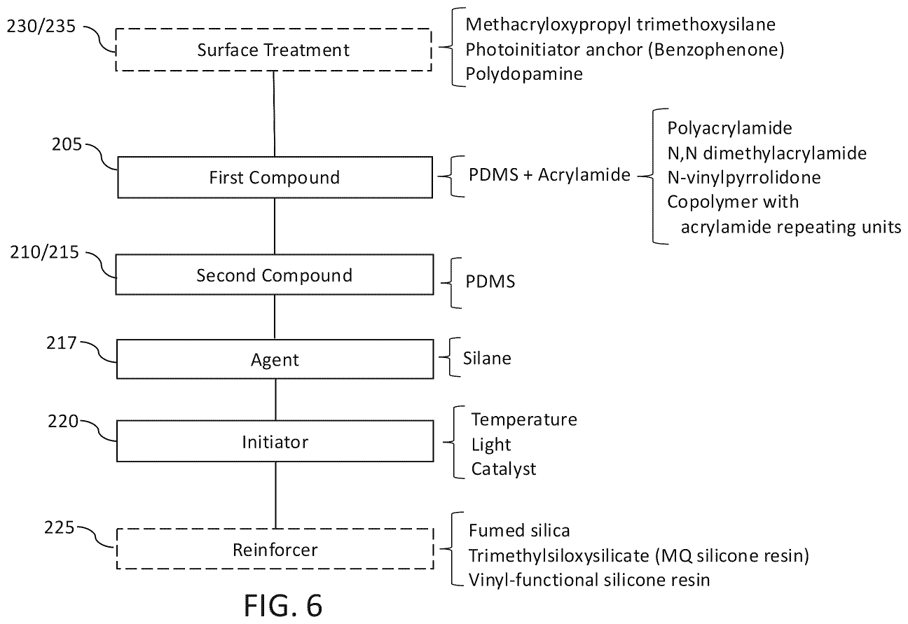

FIG. 5 is a schematic of a glucose limiting layer, and FIG. 6 is a schematic of formulations of a glucose limiting layer, both in accordance with some aspects. Referring to FIGS. 5 and 6, a glucose limiting layer 112 for a continuous biological sensor 100 includes a first layer 203 having a first compound 205, and a second layer 207 having a second compound 210, each of which may already be crosslinked internally. The first compound 205 includes PDMS crosslinked with an acrylamide. In some aspects, the acrylamide-based material comprises polyacrylamide, N,N dimethylacrylamide, N-vinylpyrrolidone, or a copolymer comprising acrylamide repeating units.

The second compound 210 may be silicone including PDMS. In this example, an agent 217 is a bonding or coupling agent positioned at an interface between the first layer 203 and the second layer 207, where the agent 217 reacts with the first compound 205 and reacts with the second compound 210 to bond the first layer 203 to the second layer 207 and reduce interlayer delamination.

In some examples, the agent 217 comprises silane which is a bonding, or coupling, agent (i.e., not a crosslinker). The silane acts as a bidirectional molecular bridge, or tie layer, facilitating bonding between the first layer 203 and the second layer 207. This interfacial reaction promises strong adhesion, prevents delamination, and improves sensor stability.

A glucose limiting layer 112 for a continuous biological sensor 100 includes a substrate 106 for the continuous biological sensor 100. A first layer 203 is on the substrate 106, and the first layer includes PDMS crosslinked with an acrylamide-based material. A second layer 207 is on the first layer 203, and the second layer 207 includes PDMS. An agent 217 is positioned between the first layer 203 and the second layer 207. The agent 217 includes silane and reacts with the first layer 203 and the second layer 207 to form covalent bonds between the first layer 203 and the second layer 207.

The first compound 205 of the first layer 203 may be formed from a first solution applied to the substrate 106. The substrate 106 may then be exposed to an initiator thereby crosslinking the PDMS to the acrylamide-based material in-situ. The initiator 220 may comprise heat, light or a catalyst.

The silane application process may include dipping the first layer 203 into a silane solution. Optionally, the silane layer may be exposed to the initiator 220, thus forming a reactive intermediate layer and enhancing bonding. The initiator 220 may comprise heat, light or a catalyst.

After the silane dip, the second layer 207 comprising the second compound 210 is applied. In some examples, the substrate 106 with the first layer 203, the silane (e.g., the agent 217) and the second layer 207 may again be exposed to the initiator 220 to enhance bonding. Exposing the substrate 106 to the initiator 220 causes the first layer 203 to be covalently bonded to the agent 217 and causes the second layer 207 to be covalently bonded to the agent 217. The pendant reactive groups of the silane covalently bond with the first layer 203 and the second layer 207, ensuring robust adhesion. For example, the silane has a first reactive group that reacts with the acrylamide-based material of the first layer 203 and a second reactive group that reacts with the PDMS of the second layer 207 during exposure. The result is a tightly linked or bonded multilayer structure that resists delamination, thereby improving the durability and performance of the glucose limiting layer 112.

The use of silane as the agent 217 in this example follows the “like-like-like” principle, which refers to the tendency of materials with similar chemical structures or properties to adhere well to each other. Since silane is a silicone-based material, it naturally bonds with other silicone materials, such as PDMS. For instance, the first compound 205 comprises PDMS crosslinked with an acrylamide, while the second compound 210 may be a silicone material that includes PDMS.

The use of an acrylamide-based material provides a reactive site capable of interacting with the agent 217 or the silane. This silane between the first layer 203 and the second layer 207 has functional groups that bond with both the first layer 203 to the second layer 207, creating a stable interface. The silane is strategically positioned between two polymeric layers (e.g., the first layer 203 and the second layer 207) to ensure strong chemical bonding in both directions. For example, the silane (e.g., the agent 217) is covalently bonded to the first layer 203 and covalently bonded to the second layer 207. Traditional adhesion promoters typically function in a unidirectional manner, reacting only with the incoming material applied over them. In contrast, the silane in the glucose limiting layer 112 facilitates bidirectional bonding, linking both the first layer 203 and the second layer 207 through chemical interactions. This approach ensures a stable, interfacial connection between layers that would otherwise separate under operational stress.

In conventional methods, an adhesion layer is often used when depositing a polymer onto a non-reactive metal or plastic substrate. These systems rely on surface energy differences to facilitate weak interactions such as van der Waals forces. For example, a common application of a silane adhesion promoter in the art involves modifying surfaces of hydrophobic polymers like polyether ether ketone (PEEK) to improve the adhesion of hydrophilic coatings. The silane layer typically interacts only with the applied hydrophilic material, leaving the underlying surface largely unaffected. This results in a limited adhesion mechanism dependent on van der Waals forces rather than chemical bonding. In contrast, the example herein leverages a silane-based bonding agent 217 that reacts with both the first layer 203 and second layer 207 in the glucose limiting layer 112 by providing direct chemical reactions between the silane bonding agent and both polymeric layers, creating a much stronger bond.

In some examples, at least one of the first solution used to form the first compound 205 and/or the second solution used to form the second compound 210 further comprises platinum as a catalyst, so that the platinum catalyst is present during the post application activation step and promotes curing and/or crosslinking.

As described in Example 1 and Example 2, this glucose limiting layer 112 of Example 3 may optionally include a reinforcer 225 to improve mechanical durability in vivo. For example, the reinforcer 225 may be included in the first solution and/or the second solution so that the reinforcer 225 remains incorporated within the resulting glucose limiting layer 112. The reinforcer may comprise one or more of a fumed silica, trimethylsiloxysilicate (MQ silicone resin), or a vinyl-functional silicone resin. In addition, the substrate 106 may optionally include surface treatments such as the primer layer 230 and/or the preliminary layer 235, as described herein, to improve adhesion and reduce delamination in the resulting multilayer glucose limiting layer.

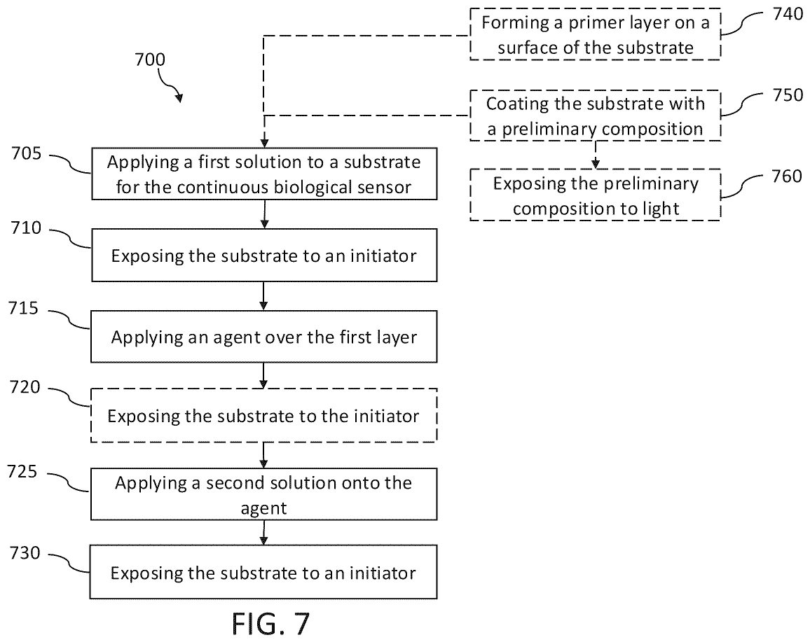

FIG. 7 is a flowchart of a method for forming a glucose limiting layer for a continuous biological sensor, in accordance with some aspects. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

The method 700 starts at block 705 by applying a first solution to a substrate for the continuous biological sensor to form a first layer on the substrate. In some examples, the first solution comprises PDMS crosslinked with an acrylamide-based material. In some examples, the first solution comprises PDMS and an acrylamide-based material. The applying the first solution comprises dip coating the substrate. In some examples, the acrylamide-based material comprises polyacrylamide, N,N dimethylacrylamide, N-vinylpyrrolidone, or a copolymer comprising acrylamide repeating units.

At block 710, the substrate is exposed to an initiator thereby crosslinking the PDMS to the acrylamide-based material in-situ. In some examples, the initiator comprises heat or light. At block 715, an agent is applied over the first layer thereby reacting with the first layer. The agent comprises silane. The applying the agent comprises dip coating the substrate. Optionally, at block 720, the substrate is exposed to an initiator thereby bonding the first layer to the agent. In some examples, the initiator comprises heat or light.

At block 725, a second solution is applied onto the agent to form a second layer. The second solution comprises PDMS. The applying the second solution comprises dip coating the substrate. At block 730, the substrate is exposed to the initiator thereby bonding the PDMS to the agent in-situ. In some examples, the initiator comprises heat or light. The agent is allowed to bond the first layer to the second layer. For example, the agent is covalently bonded to the first layer and covalently bonded to the second layer. The agent facilitates bidirectional bonding by reacting with both the first layer and the second layer.

The method 700 may be repeated by repeating blocks 705-730 to increase a thickness of the glucose limiting layer. For example, the method 700 may be repeated multiple times until a target thickness of the glucose limiting layer is achieved. In some scenarios, the target thickness of the glucose limiting layer is 12 microns to 20 microns.

Before blocks 705-730, optionally, at block 740, a primer layer may be formed on a surface of the substrate. This may improve wetting of the substrate by subsequently applied solutions and increase adhesion of the glucose limiting layer to the substrate to reduce delamination. The primer layer may comprise polydopamine or methacryloxypropyl trimethoxysilane.

Before blocks 705-730, optionally, at block 750, the substrate may be coated with a preliminary composition. The preliminary composition may comprise a photoinitiator anchor. This may promote surface-initiated attachment of subsequently applied layers to increase adhesion to the substrate and reduce delamination. At block 760, the preliminary composition is exposed to light to initiate an in situ reaction on the substrate to form a preliminary layer 235. In some examples, the photoinitiator anchor comprises benzophenone.

### EXAMPLE 4

### Glucose Limiting Layer With (Vinyl-Terminated PDMS+Crosslinker)

In silicone-based membranes for continuous biological sensors, a recurring practical problem is forming a very thin, uniform, defect resistant layer while keeping the coating process controllable. PDMS is attractive for biocompatibility and chemical stability, but a membrane still needs a reliable way to convert a flowable coating into a durable elastomeric network without introducing voids, shrinkage, or other thickness nonuniformities that can change diffusion behavior. Vinyl-terminated PDMS addresses this by providing defined reactive sites at the polymer chain ends, so crosslinking can be delayed until after the coating has leveled and conformed to the substrate. In other words, the coating step can prioritize wetting and uniformity, and the network formation step can be triggered afterward to lock in the final membrane structure.

A crosslinker having silicon hydride Si—H functionality is commonly paired with vinyl-terminated PDMS because the combination supports a platinum catalyzed addition cure reaction in which Si—H groups add across the vinyl carbon-carbon double bonds to form a crosslinked silicone network. This addition reaction is widely used in silicone systems and is valued because it proceeds without forming volatile reaction byproducts, which helps maintain dimensional stability in thin films and reduces the risk of defects that can arise in byproduct forming chemistries when the network is activated by heat, light, or a catalyst. It also provides a lever for tuning network density and mechanical properties through selection of the Si—H functionality and the relative amounts of reactive groups. This example uniquely provides an insight of using this vinyl configuration in a glucose limiting layer, which has not been done in conventional devices. In manufacturing, platinum-catalyzed systems can be sensitive to inhibition from some contaminants, so selecting compatible materials and maintaining clean processing conditions can help the reaction proceed as intended when triggered by heat, light, or a catalyst.

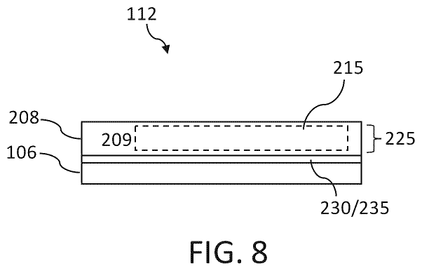

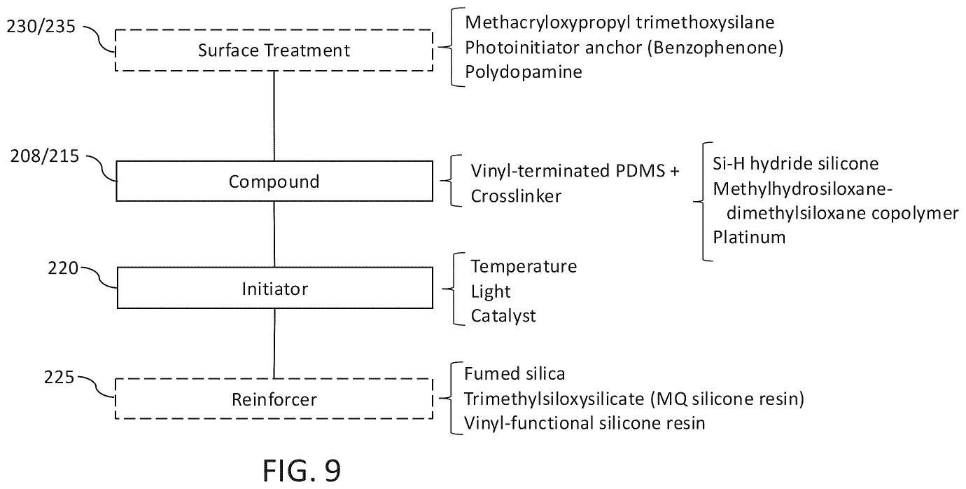

FIG. 8 is a schematic of a glucose limiting layer, and FIG. 9 is a schematic of formulations of a glucose limiting layer, both in accordance with some aspects. A glucose limiting layer 112 for a continuous biological sensor 100 includes a substrate 106 and a layer 208. The layer 208 may be a single layer having a compound 209. The compound 209 of the layer 208 may be formed from a solution applied to the substrate 106.

The compound 209 includes vinyl-terminated PDMS and a crosslinker 215. In this example, the crosslinker 215 is a crosslinking agent and crosslinks the compound 209. In some examples, the crosslinker 215 may be a Si—H hydride silicone or a methylhydrosiloxane-dimethylsiloxane copolymer. To initiate the crosslinking process, an initiator 220 may be applied to the reaction. In some aspects, the initiator 220 is temperature, light or a catalyst. In this example, the initiator 220 is temperature such that heat is applied.

In some examples, the solution used to form the compound 209 further comprises platinum as a catalyst, so that the platinum catalyst is present during a post application activation step. In such examples, when the solution includes vinyl-terminated PDMS and a crosslinker having silicon hydride Si—H functionality, the platinum catalyst can promote the addition reaction between the Si—H groups and the vinyl functionality when activation is provided by the initiator 220 (e.g., heat, light, or a catalyst).

In some aspects, a glucose limiting layer 112 for a continuous biological sensor 100 includes a substrate 106 for the continuous biological sensor 100. A layer 208 is on the substrate, and the layer includes vinyl-terminated PDMS and a crosslinker 215. The vinyl-terminated PDMS is crosslinked to the crosslinker 215.

In this example, applying the solution may comprise dip coating the substrate to form the layer 208. After the dip coating step, the substrate is exposed to an initiator to crosslink the vinyl-terminated PDMS with the crosslinker in situ. The dip cycle, involving applying the solution, then exposing the substrate to the initiator 220, may be repeated to reach a target thickness. The exposure to the initiator step may be performed after each dip or after multiple dips, depending on the selected processing sequence.

As described herein, the glucose limiting layer 112 may optionally include a reinforcer 225 to improve mechanical durability in vivo. For example, the reinforcer 225 may be included in the solution so that the reinforcer 225 remains incorporated within the resulting glucose limiting layer 112. The reinforcer 225 may comprise one or more of a fumed silica, trimethylsiloxysilicate (MQ silicone resin), or a vinyl-functional silicone resin. In addition, the substrate 106 may optionally include surface treatments such as the primer layer 230 and/or the preliminary layer 235, as described herein, to improve adhesion and reduce delamination in the resulting glucose limiting layer.

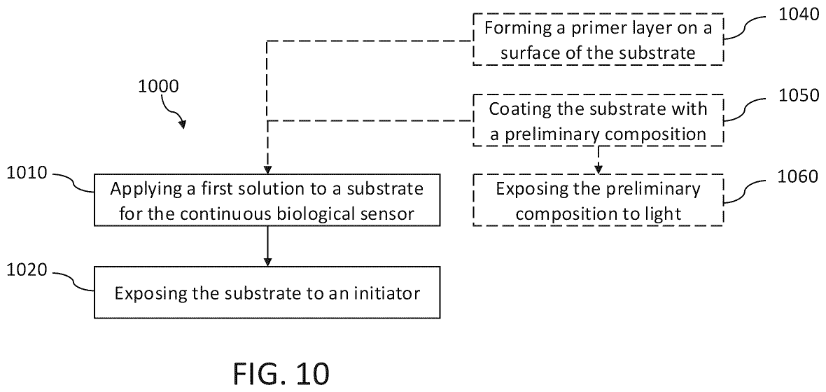

FIG. 10 is a flowchart of a method for forming a glucose limiting layer for a continuous biological sensor, in accordance with some aspects. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

A method 1000 for forming a glucose limiting layer for a continuous biological sensor 100 starts at block 1010 by applying a solution to a substrate for the continuous biological sensor 100. The solution comprises vinyl-terminated PDMS and a crosslinker to form a layer on the substrate. In some examples, a molecular weight of the vinyl-terminated PDMS is selected to control viscosity or elastic modulus. This provides a desired solution viscosity and coating behavior during application, such as to support uniform dip coating. The selected molecular weight can also be used to target an elastic modulus of the resulting glucose limiting layer after crosslinking. The crosslinker may comprise a Si—H hydride silicone or a methylhydrosiloxane-dimethylsiloxane copolymer. In some examples, the applying the solution comprises dip coating the substrate.

At block 1020, the substrate is exposed to an initiator to crosslink the vinyl-terminated PDMS with the crosslinker in situ. In some examples, the initiator comprises heat, light, or a catalyst that activates the crosslinker. For example, after the solution is applied, a thermal tunnel may be used to provide heat as the activation condition. In another example, the solution further includes platinum as a catalyst, so that the platinum catalyst is present during the activation step and promotes the addition reaction between Si—H functionality of the crosslinker and vinyl functionality of the vinyl-terminated PDMS to form a crosslinked silicone network. This may be performed with heat or, in some examples, without added heat.

The method 1000 is repeated (e.g., blocks 1010 and 1020) such as the applying the solution and the exposing the substrate to the initiator to increase a thickness of the glucose limiting layer. In some scenarios, the thickness of the glucose limiting layer is 12 microns to 20 microns.

In some examples, the solution further comprises a hydrophilic additive comprising polyethylene oxide repeating units selected from polyethylene oxide (PEO), poly(ethylene glycol) (PEG), a PEG derivative, or a PEG-containing copolymer.

Before blocks 1010-1020, optionally, at block 1040, a primer layer may be formed on a surface of the substrate. This may improve wetting of the substrate by subsequently applied solutions and increase adhesion of the glucose limiting layer to the substrate to reduce delamination. The primer layer may comprise polydopamine or methacryloxypropyl trimethoxysilane.

Before blocks 1010-1020, optionally, at block 1050, the substrate may be coated with a preliminary composition. The preliminary composition may comprise a photoinitiator anchor. This may promote surface-initiated attachment of subsequently applied layers to increase adhesion to the substrate and reduce delamination. At block 1060, the preliminary composition is exposed to light to initiate an in situ reaction on the substrate to form a preliminary layer 235. In some examples, the photoinitiator anchor comprises benzophenone.

Reference has been made in detail to aspects of the disclosed invention, one or more examples of which have been illustrated in the accompanying figures. Each example has been provided by way of explanation of the present technology, not as a limitation of the present technology. In fact, while the specification has been described in detail with respect to specific aspects of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method for forming a glucose limiting layer for a continuous biological sensor comprising:
applying a solution to a substrate for the continuous biological sensor, the solution comprising vinyl-terminated polydimethylsiloxane (PDMS) and a crosslinker to form a layer on the substrate; and
exposing the substrate to an initiator thereby crosslinking the vinyl-terminated PDMS with the crosslinker in situ.

2. The method of claim 1, wherein the initiator comprises heat or light to activate the crosslinker.

3. The method of claim 2, wherein the solution further comprises platinum (Pt) as a catalyst.

4. The method of claim 1, wherein the crosslinker comprises a Si—H hydride silicone.

5. The method of claim 1, wherein the crosslinker comprises a methylhydrosiloxane-dimethylsiloxane copolymer.

6. The method of claim 1, wherein a molecular weight of the vinyl-terminated PDMS is selected to control viscosity or elastic modulus.

7. The method of claim 1, wherein the solution further comprises a hydrophilic additive comprising polyethylene oxide repeating units.

8. The method of claim 7, wherein the polyethylene oxide repeating units is selected from polyethylene oxide (PEO), poly(ethylene glycol) (PEG), a PEG derivative, or a PEG-containing copolymer.

9. The method of claim 1, wherein the applying the solution comprises dip coating the substrate.

10. The method of claim 1, further comprising repeating the applying the solution, and the exposing the substrate to the initiator to increase a thickness of the glucose limiting layer.

11. The method of claim 10, wherein the thickness of the glucose limiting layer is 12 microns to 20 microns.

12. The method of claim 1, wherein the solution further comprises a reinforcer, wherein the reinforcer comprises one or more of a fumed silica, trimethylsiloxysilicate (MQ silicone resin), or a vinyl-functional silicone resin.

13. The method of claim 1, further comprising:
before the applying, coating the substrate with a preliminary composition, the preliminary composition comprising a photoinitiator anchor; and
exposing the preliminary composition to light to initiate an in situ reaction on the substrate to form a preliminary layer.

14. The method of claim 13, wherein the photoinitiator anchor comprises benzophenone.

15. The method of claim 1, further comprising:
before the applying of the solution, forming a primer layer on a surface of the substrate, wherein the primer layer comprises polydopamine or methacryloxypropyl trimethoxysilane.

16. A glucose limiting layer for a continuous biological sensor comprising:
a substrate for the continuous biological sensor; and
a layer on the substrate, the layer comprising vinyl-terminated PDMS and a crosslinker, wherein the vinyl-terminated PDMS is crosslinked to the crosslinker.

17. The glucose limiting layer of claim 16, wherein the crosslinker comprises a Si—H hydride silicone.

18. The glucose limiting layer of claim 16, wherein the crosslinker comprises a methylhydrosiloxane-dimethylsiloxane copolymer.

19. The glucose limiting layer of claim 16, wherein the layer further comprises a reinforcer, wherein the reinforcer comprises one or more of a fumed silica, trimethylsiloxysilicate (MQ silicone resin), or a vinyl-functional silicone resin.

20. The glucose limiting layer of claim 16, wherein a thickness of the glucose limiting layer is 12 microns to 20 microns.
